(19) United States
(12) Patent Application Publication
(10) Pub. No.: US 2013/0174620 A1
(43) Pub. Date: Jul. 11, 2013

(54) DEVICE AND METHOD FOR CONTROLLING ELECTRIC LOCK

(71) Applicants: WEI-YU CHEN, NEW TAIPEI CITY (TW); CHING-FENG HSIEH, TAIPEI CITY (TW)

(72) Inventors: WEI-YU CHEN, NEW TAIPEI CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/418,411

(22) Filed: Mar. 13, 2012

(30) Foreign Application Priority Data
Jan. 6, 2012 (TW) 101100567

(51) Int. Cl. E05B 49/00

(52) U.S. Cl. 70/266

(57) ABSTRACT

A device and method for controlling an electric lock control the electric lock by generating a password signal carrying an ID information from an electronic apparatus including a communication chip. The device includes an antenna unit, a communication unit, a processing module, and a memory unit. The processing module receives the password signal from the electronic apparatus via the communication unit and the antenna unit. The processing module controls a locked status of the electric lock based on the password signal. The ID information carried by the password signal is analyzed by the processing module and sent to the memory unit and stored therein to form a reference information. Once the processing module receives the password signal again, the processing module will determine whether to maintain or change the locked status of the electric lock based on a result of comparison of the password signal and the reference information.

### CROSS-REFERENCE TO RELATED APPLICATION

This non-provisional application claims priority under 35 U.S.C. §119(a) on Patent Application No(s).101100567 filed in Taiwan, R.O.C. on Jan 6, 2012, the entire contents of which are hereby incorporated by reference.

### FIELD OF TECHNOLOGY

The present invention relates to devices and methods for controlling an electric lock, and more particularly, to a device and method for controlling an electric lock by matching an electronic apparatus.

### BACKGROUND

According to the prior art, a safe or a locker is locked and unlocked with a mechanical dial so that articles kept in the safe and the locker are protected against theft.

Due to the wide use of mobile communication apparatuses, a notable trend is that safes and lockers nowadays feature smart control. For example, to start using a safe or a locker, users enter the phone numbers of their mobile communication apparatuses into the safe or the locker, and then the safe or the locker generates and sends a password to the users' mobile communication apparatuses by an instant message, thereby allowing the users to start the safe or the locker with the password.

Nonetheless, the aforesaid password-based protection is not absolutely safe, as the password being sent to the users' mobile communication apparatuses can go astray, or can even be stolen.

In view of the aforesaid drawbacks of the prior art, the present invention provides a device and method for controlling an electric lock with a view to overcoming the aforesaid drawbacks of the prior art.

### SUMMARY

It is an objective of the present invention to provide a device for controlling an electric lock, such that the device enables a user to configure an electronic apparatus (such as a mobile communication apparatus) for controlling a password required for the electric lock, so as to enhance the secrecy, security, and sophistication of the electric lock.

Another objective of the present invention is to provide a method for controlling an electric lock such that the electric lock can be locked and unlocked in a smart, controlled manner.

In order to achieve the above and other objectives, the present invention provides a device for controlling an electric lock by a password signal generated from an electronic apparatus having a communication chip. The password signal carries an ID information. The device comprises an antenna unit, a communication unit, a processing module, and a memory unit. The antenna unit receives the password signal. The communication unit is connected to the antenna unit for communicating with the communication chip through the antenna unit. The processing module has a decoding unit and a comparing unit which are connected to the communication unit and the electric lock, respectively. The decoding unit retrieves the ID information from the password signal. The comparing unit generates a control signal based on the ID information retrieved to drive the electric lock to enter a locked status. The memory unit is connected to the processing module for saving the ID information as a reference information.

In order to achieve the above and other objectives, the present invention provides a method for controlling an electric lock. The method for controlling an electric lock is applicable to the electric lock having an electric lock controlling device and adapted to control the electric lock by a password signal generated from an electronic apparatus having a communication chip. The password signal carries an ID information. The method comprises the steps of: providing communication between the electric lock controlling device and the communication chip to enable the electric lock controlling device to receive the password signal generated from the electronic apparatus; retrieving the ID information from the password signal and saving the ID information retrieved in the electric lock controlling device as a reference information; and determining whether the reference information has been stored in the electric lock controlling device, and locking the electric lock in response to an affirmative determination to cause the electric lock to enter a locked status.

Unlike the prior art, the present invention provides a device and method for controlling an electric lock, such that a unique password information generated by an electronic apparatus having a communication chip can be received. The password information comprises a single or a plurality of hardware information, such as Media Access Control address (MAC address) and/or a user-defined password. After the password information has been received by the device, the password information can be used to control the locking and unlocking of the electric lock and eventually ensures that the electric lock can be unlocked only by the electronic apparatus that configures the password initially.

Furthermore, the device and method of the present invention overcome the aforesaid drawbacks of the prior art by means of a communication unit in wide use with electronic apparatuses. Examples of the communication unit are those communication units which comply with a Bluetooth protocol or a Wi-Fi protocol

### BRIEF DESCRIPTION

Objectives, features, and advantages of the present invention are hereunder illustrated with specific embodiments in conjunction with the accompanying drawings, in which:

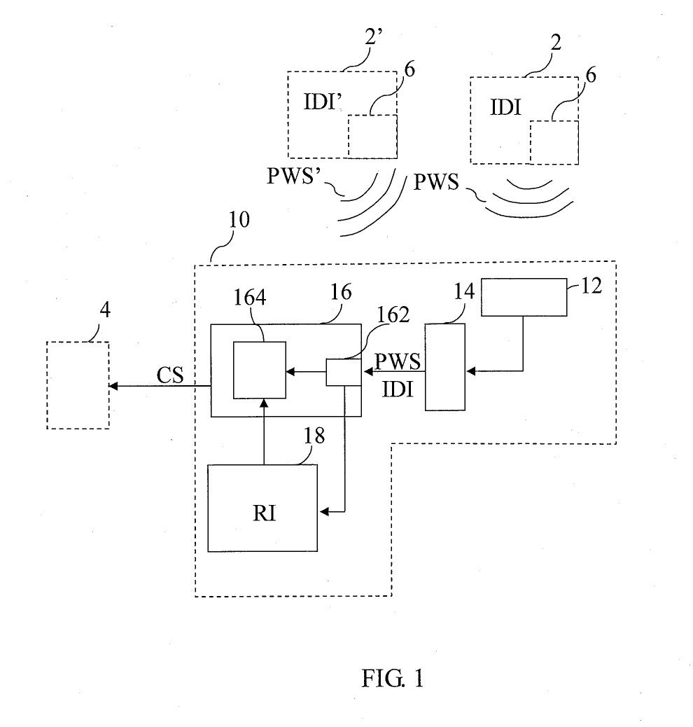

FIG. 1 is a schematic block diagram of a device for controlling an electric lock according to the first embodiment of the present invention;

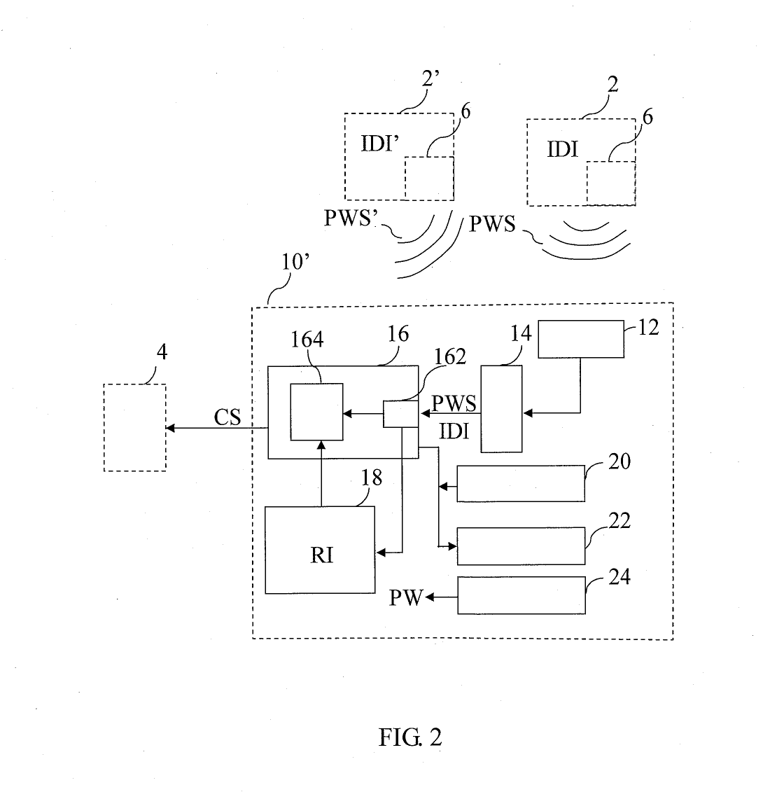

FIG. 2 is a schematic block diagram of the device for controlling an electric lock according to the second embodiment of the present invention;

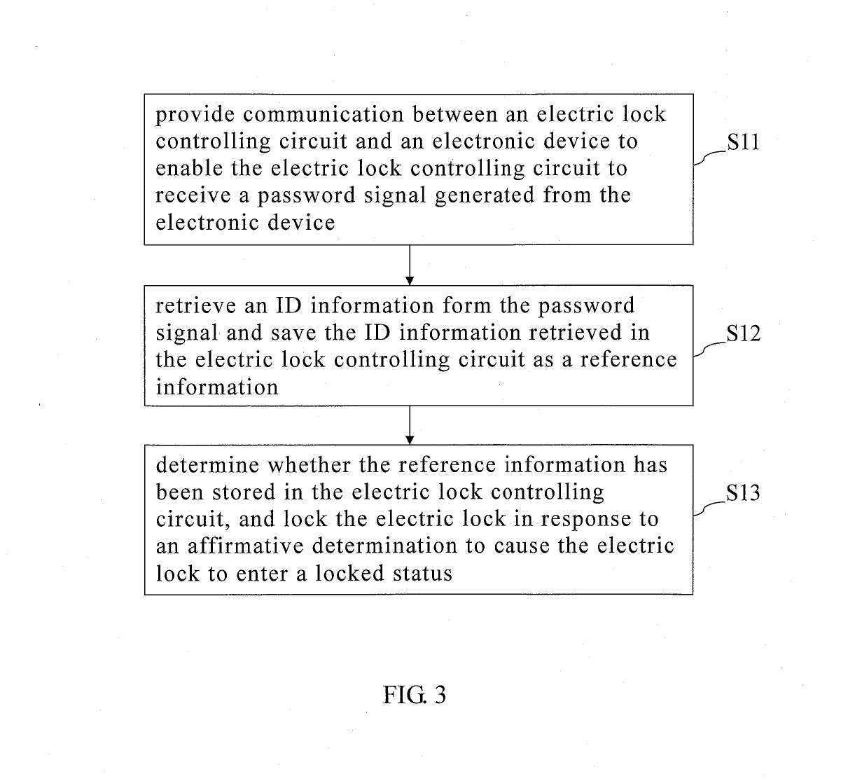

FIG. 3 is a flow chart of a method for controlling an electric lock according to the first embodiment of the present invention; and

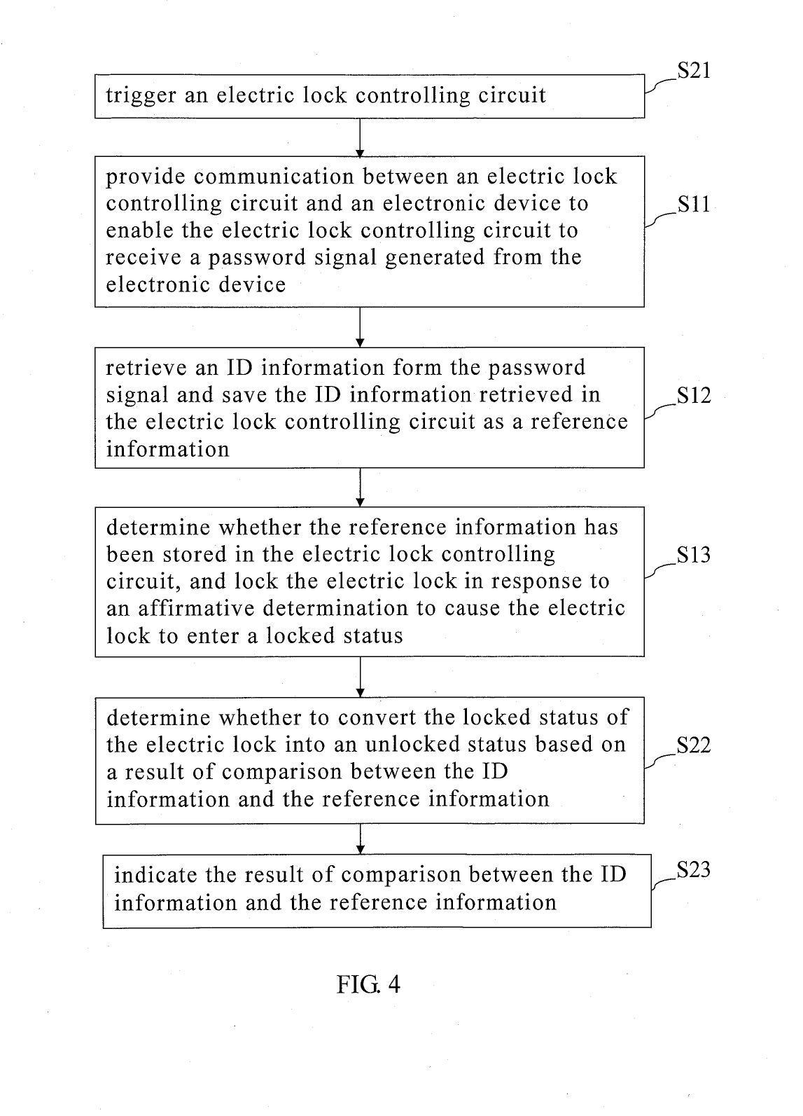

FIG. 4 is a flow chart of the method for controlling an electric lock according to the second embodiment of the present invention.

### DETAILED DESCRIPTION

Referring to FIG. 1, there is shown a schematic block diagram of a device 10 for controlling an electric lock 4 according to the first embodiment of the present invention. As shown in FIG. 1, the device 10 controls the locking and unlocking of the electric lock 4 with a password signal PWS generated by an electronic apparatus 2. The password signal PWS carries an ID information (IDI). The electronic apparatus 2 is a tablet computer, a notebook computer, or a cell phone. The electronic apparatus 2 is installed with an operating system, such as Apple's iOS, Google's Android, or Microsoft's Windows mobile or Win 8.

The electronic apparatus 2 comprises a communication chip 6 for communicating with the device 10. For example, the communication chip 6 is Bluetooth enabled or Wi-Fi enabled. The communication chip 6 contains a standardized, unique Media Access Control address (MAC address) and a user-defined username.

The device 10 comprises an antenna unit 12, a communication unit 14, a processing module 16, and a memory unit 18. The antenna unit 12 receives the password signal PWS, and operates in conjunction with the communication unit 14. Hence, the type of the antenna unit 12 in use depends on the communication unit 14

The communication unit 14 is connected to the antenna unit 12, and communicates with the electronic apparatus 2 through the antenna unit 12. For example, the communication unit 14 is Bluetooth enabled or Wi-Fi enabled. Furthermore, both the communication unit 14 and the communication chip 6 are governed by same protocol.

The processing module 16 comprises a decoding unit 162 and a comparing unit 164. In an embodiment, the processing module 16 is connected to the communication unit 14. In another embodiment, the processing module 16 is connected to the electric lock 4. After the processing module 16 has received the password signal PWS from the communication unit 14, the decoding unit 162 of the processing module 16 retrieves the ID information IDI from the password signal PWS. The comparing unit 164 of the processing module 16 sends to the electric lock 4 a control signal CS according to the ID information IDI retrieved. The control signal CS causes the electric lock 4 to enter a locked status. The locked status is defined as one where the electric lock 4 has been locked. Conversely, the unlocked status is defined as one where the electric lock 4 has been unlocked.

The memory unit 18 is connected to the processing module 16. The memory unit 18 saves the ID information IDI as a reference information RI. For example, the memory unit 18 is a cache memory, a flash memory, a read-only memory, or a volatile memory. The memory unit 18 falls within two categories, namely one built in the processing module 16 (such as a flash memory), and the other one independent of the processing module 16 (such as a flash memory, a read-only memory, or a volatile memory.) The reference information RI is a Media Access Control address (MAC address) of the electronic apparatus 2, a user-defined password, and/or a user-defined username of the communication unit 14.

In an embodiment, after the processing module 16 has received again the password signal PWS generated from same said electronic apparatus 2, the comparing unit 164 of the processing module 16 compares the reference information RI with the ID information IDI of the password signal PWS. Furthermore, with the password signal PWS being generated by the same electronic apparatus 2, the ID information IDI retrieved is the same as the reference information RI, thereby enabling the changeability of the locking/unlocked status of the electric lock 4. Conversely, if the ID information IDI retrieved is different from the reference information RI, the device 10 can wait. It is because the processing module 16 will generate the control signal CS for converting the locked status of the electric lock 4 into the unlocked status only if the ID information IDI retrieved is identical to the reference information RI. If the processing module 16 receives a password signal PWS′ generated from an electronic apparatus 2′, the processing module 16 will maintain the locked status of the electric lock 4 and thus fail to perform an unlocking operation on the electric lock 4, because the ID information IDI′ of the electronic apparatus 2′ is different from the ID information IDI of the electronic apparatus 2.

Referring to FIG. 2, there is shown a schematic block diagram of a device 10′ for controlling the electric lock 4 according to the second embodiment of the present invention. As shown in FIG. 2, the device 10′ controls the electric lock 4 with the password signal PWS generated by the electronic apparatus 2. The electronic apparatus 2 comprises the communication chip 6. The password signal PWS carries the ID information (IDI). The device 10′ comprises the antenna unit 12, the communication unit 14, the processing module 16, and the memory unit 18. The second embodiment differs from the first embodiment in that the device 10′ in the second embodiment further comprises a triggering unit 20 connected to the processing module 16 for triggering the processing module 16 to receive the password signal PWS. For example, the triggering unit 20 is a button or a touch panel. To generate the password signal PWS with the electronic apparatus 2, the user uses the triggering unit 20 to trigger the processing module 16 and thereby prevents a waste of electric power which might otherwise be consumed by the processing module 16.

In another embodiment, the device 10′ further comprises an indicating unit 22 connected to the processing module 16 for indicating a result of comparison of the ID information IDI and the reference information RI. That is to say, the indicating unit 22 enables the user to understand whether the password information PWS generated from the electronic apparatus 2 is acceptable by the device 10′. The indicating unit 22 is an indicator or a display screen.

In yet another embodiment, the device 10′ further comprises a power supply unit 24 connected to the communication unit 14, the processing module 16, and the memory unit 18 for supplying power PW to the communication unit 14, the processing module 16, and the memory unit 18. For example, the power supply unit 24 is an external power source (such as grid power, or a solar cell) or a built-in power source (such as a primary battery or a secondary battery).

Referring to FIG. 3, there is shown a flow chart of a method for controlling an electric lock according to the first embodiment of the present invention. As shown in FIG. 3, the method enables the device 10 to control the electric lock 4 with the password signal PWS generated by the electronic apparatus 2. The electronic apparatus 2 comprises the communication chip 6. The password signal PWS carries the ID information IDI. The device 10 comprises the communication unit 14, the processing module 16, and the memory unit 18.

The process flow of the method begins with step S11 which involves providing communication between the communication unit 14 and the electronic apparatus 2 so as for the device 10 to receive the password signal PWS generated from the electronic apparatus 2. The communication unit 14 of the device 10 communicates with the electronic apparatus 2 by the same protocol, such as a Bluetooth protocol or a Wi-Fi protocol.

In step S12, the ID information IDI is retrieved from the password signal PWS, stored in the device 10, and configured as the reference information RI. Hence, the device 10 stores the latest reference information RI by way of this step.

Step S13 involves determining whether the reference information RI is stored so as to perform a locking operation on the electric lock 4 and cause the electric lock to enter the locked status. In this step, if the reference information RI is stored in the memory unit 18, the processing module 16 will instruct the electric lock 4 to enter the locked status. Conversely, in the situation where the reference information RI is not stored in the memory unit 18, the processing module 16 does not perform the locking operation on the electric lock 4 unless and until the reference information RI is stored in the memory unit 18. That is to say, the electric lock 4 will enter the locked status, only if the memory unit 18 finishes configuring the reference information RI

Referring to FIG. 4, there is shown a flow chart of the method for controlling an electric lock according to the second embodiment of the present invention. As shown in FIG. 4, in addition to steps S11˜S13, the method further comprises step S21, step S22, and step S23.

Step S21 precedes step S11 and involves triggering, before providing communication between the device 10 and the electronic apparatus 2, the device 10 to receive the password signal PWS. In step S21, execution of related steps of the method is determined in advance according to whether the device is triggered. Hence, the device 10 will be started in order to receive, store, and compare the password signal PWS and/or the reference information RI and control a related operation, only if the user wants the electric lock 4 to enter the locking or unlocked status.

Step S22 follows step S13 and involves determining whether to convert the locked status of the electric lock 4 into the unlocked status based on a result of comparison between the ID information IDI and the reference information RI when the device 10 has received the password signal PWS and the electric lock 4 is at the locked status.

Step S23 follows step S22 and involves indicating a result of comparison between the ID information IDI and the reference information RI. Due to step S23, the user gains insight into whether the ID information IDI is identical to the reference information RI or not.

Accordingly, the present invention provides a device and method for controlling an electric lock, such that a unique password information generated by an electronic apparatus having a communication chip can be received. The password information comprises a single or a plurality of hardware information, such as Media Access Control address (MAC address) and/or a user-defined password. After the password information has been received by the device, the password information can be used to control the locking and unlocking of the electric lock and eventually ensures that the electric lock can be unlocked only by the electronic apparatus that configures the password initially.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A device for controlling an electric lock, by a password signal generated from an electronic apparatus having a communication chip, the password signal carrying an ID information, the device comprising:
an antenna unit for receiving the password signal;
a communication unit connected to the antenna unit for communicating with the communication chip through the antenna unit;
a processing module having a decoding unit and a comparing unit, the decoding unit being connected to the communication unit for retrieving the ID information from the password signal, the comparing unit being connected to the electric lock for generating a control signal based on the ID information retrieved to drive the electric lock to enter a locked status; and
a memory unit connected to the processing module for saving the ID information as a reference information.

2. The device of claim 1, further comprising a triggering unit connected to the processing module for triggering the processing module to receive the password signal.

3. The device of claim 1, wherein the communication chip and the communication unit are Bluetooth enabled or Wi-Fi enabled.

4. The device of claim 1, wherein the reference information is at least one of a unique Media Access Control address of the electronic apparatus, a user-defined password, and a username of the communication unit.

5. The device of claim 1, wherein, when the electric lock is at the locked status and the processing module receives the password signal, the comparing unit compares the ID information with the reference information to determine whether to convert the locked status of the electric lock into an unlocked status.

6. The device of claim 5, further comprising an indicating unit connected to the processing module for indicating a result of comparison between the ID information and the reference information.

7. The device of claim 1, wherein the electronic apparatus is one of a tablet computer, a notebook computer, and a cell phone.

8. The device of claim 1, further comprising a power supply unit connected to the communication unit, the processing module, and the memory unit for supplying electric power to the communication unit, the processing module, and the memory unit.

9. A method for controlling an electric lock, applicable to the electric lock having an electric lock controlling device and adapted to control the electric lock by a password signal generated from an electronic apparatus having a communication chip, the password signal carrying an ID information, the method comprising the steps of:
providing communication between the electric lock controlling device and the communication chip to enable the electric lock controlling device to receive the password signal generated from the electronic apparatus;
retrieving the ID information from the password signal and saving the ID information retrieved in the electric lock controlling device as a reference information; and
determining whether the reference information has been stored in the electric lock controlling device, and locking the electric lock in response to an affirmative determination to cause the electric lock to enter a locked status.

10. The method of claim 9, further comprising the step of triggering, before the step of providing communication between the electric lock controlling device and the communication chip, the electric lock controlling device to receive the password signal.

11. The method of claim 9, further comprising the step of determining, when the electric lock is at the locked status and the electric lock controlling device receives the password signal, whether to convert the locked status of the electric lock into an unlocked status based on a result of comparison between the ID information and the reference information.

12. The method of claim 11, further comprising the step of indicating the result of comparison between the ID information and the reference information by an indicating unit.
